(19) United States
(12) Patent Application Publication
(10) Pub. No.: US 2026/0131550 A1
(43) Pub. Date: May 14, 2026

(54) METHOD FOR MANUFACTURING A CARTRIDGE FROM RECYCLED MATERIAL AND CARTRIDGE

(71) Applicant: Ritter GmbH, Schwabmünchen (DE)

(72) Inventors: Roman PREUß, Friedberg (DE); Samuel KREBBER, Königsbrunn (DE); Frank FINIS, Augsburg (DE); Frank NOVAK, Bobingen (DE)

(21) Appl. No.: 19/443,932

(22) Filed: Jan. 8, 2026

Related U.S. Application Data
(63) Continuation-in-part of application No. 18/810,864, filed on Aug. 21, 2024.

(30) Foreign Application Priority Data
Aug. 21, 2023 (DE) 102023122330.5

(51) Int. Cl. B29D 22/00; B29K 105/26

(52) U.S. Cl. CPC B29D 22/003; B29K 2105/26

(57) ABSTRACT

A plastic product, for example a cartridge, comprises at least 5 wt. % to 100 wt. % recycled material. A method for manufacturing such a plastic product may include providing a partially recycled material comprising at least 5 wt. % recycled material and applying an injection molding or extrusion process to produce the base body of the plastic product. The base body is pre-treated, and a white paint is applied as a base coat to a print area located on the outside of the base body as a primer for subsequent (e.g., color) printing. The method then includes directly printing on the white base coat of the print area using direct digital printing.

### FIELD

The application relates to a method for manufacturing a plastic product, and to a plastic product manufactured by using the method.

### INTRODUCTION

Plastic products are widely used because they are lightweight, inexpensive to manufacture, robust and therefore practical. Plastic products and plastic packaging are indispensable in a variety of applications, including the storage of chemicals for construction purposes, such as silicone, acrylic, etc. However, the more plastic containers are used, the greater the challenges in terms of sustainability. The use of recycled materials, such as PCR (post-consumer recycled) or PIR (post-industrial recycled) material, reduces the problem of lack of sustainability.

Recycled materials are unsuitable or difficult to handle for many applications. This is because the material properties are not defined due to different types and degrees of contamination in different batches of recycled material. These undefined properties can affect the geometry, e.g., the shrinkage dimensions. In addition, contaminants can interact with the filler in a cartridge as well as with imprints or coatings applied to the outside of the cartridge and impair their effectiveness.

When printing on recycled surfaces, problems arise due to heterogeneous composition and contamination, which occur in particular with post-consumer recyclates (PCR), but also with post-industrial recyclates (PIR), due to the mixing of different types of plastic and residues of additives. This leads to fluctuating surface properties. Physically, recycled surfaces have a lower surface energy, which can affect wettability and adhesion.

Another problem may be the lower, more uneven opacity of recycled materials. These are usually not white, but dark or black in color, making them more difficult to print on. As a rule, printed labels are therefore used.

### SUMMARY

Based on this, the object of the present disclosure is to present a sustainable process for manufacturing a plastic product in a recycling process without compromising product quality.

The present disclosure provides systems, apparatuses, and methods relating to plastic products, and relates to a method for manufacturing a plastic product, in particular a cartridge, comprising the following steps: providing (partially) recycled plastic material comprising at least 5% by weight of recycled material; and applying an injection molding or extrusion process to manufacture the base body of the plastic product.

Features, functions, and advantages may be achieved independently in various embodiments of the present disclosure, or may be combined in yet other embodiments, further details of which may be seen with reference to the following description and drawings.

### DETAILED DESCRIPTION

In general, the present disclosure describes methods of manufacturing a sustainable plastic product in a recycling process without considerably impairing the product quality. Previously known products and methods do not use PCR material, as it is difficult a) to produce cartridges using PCR material, and b) to print, especially clearly, on PCR material.

In some examples, a method for manufacturing at least one component of a plastic product, in particular a cartridge, includes the following steps:
(a) Provision of (partially) recycled plastic material comprising at least 5% by weight of recycled material;
(b) Application of an injection molding or extrusion process for manufacturing a base body of the plastic product;
(c) Pre-treatment of the base body of the plastic product;
(d) Applying white paint/ink as a base coat to a print area located on the outside of the base body as a primer for subsequent color printing;
(e) Direct printing on the white base coat of the print area using direct digital printing or a combination of direct digital printing with another printing process.

Recycled plastic material (recyclate) may be any recycled plastic material. A distinction is usually made between PCR (post-consumer recycled) material, which is obtained from food packaging waste, such as PET bottles, etc. PCR (post-consumer recycled) material usually contains at least 1-5% by weight of foreign matter and/or contaminants, in particular at least 3-5% by weight of foreign matter and/or contaminants. PCR is therefore a plastic made from consumer waste. These recycled plastics are also referred to as rPET (recycled polyethylene terephthalate), rPP (recycled polypropylene plastic), rHDPE (recycled high-density polythene), etc.

In addition to PCR (post-consumer recycled), a recyclate may also contain PIR (post-industrial recycled). PIR (post-industrial recycled) is industrial plastic waste that is generated during production, for example. A recycled material (recyclate) within the meaning of the present disclosure may contain PCR material and PIR material in all possible mixing ratios. The plastic material may contain recycled material and a mixture of recycled material and “virgin material” (i.e. non-recycled material).

When using an injection molding process in step (b), the inner contour or outer contour of a tool used, e.g. a cavity and/or a core, may have a draft angle (demolding bevel) of 0.01° to 5°, in particular 0.01° to 2°, and in particular 0.01° to 1°, corresponding to the complementary outer contour and the complementary inner contour, respectively, of the component of the plastic product.

Step (c) serves to improve the adhesion of the primer or printing ink to the base body/substrate.

Step (d) is important for the process in most cases, as opaque white serves as a primer for subsequently applied colors, especially on transparent or dark substrates. Step (d) may be carried out in a separate printing unit, often with a higher layer thickness. The white base coat may be applied in one, two or more layers (e.g. printing processes). In addition to the white coloring, which improves the intensity, color fastness and brilliance of the subsequently applied (color) print, the white color may increase the adhesion of subsequently applied layers. Furthermore, the white color layer may reduce diffusion through a container wall. The white layer may be applied inline, nearline or manually.

In step (e), a digital direct printing process may used, possibly in combination with other printing processes. In digital printing processes, the print image is transferred directly from a digital file from a computer module to the printing machine. Examples of digital printing processes are inkjet printing or electrophotography (e.g. toner-based printing). In each case, the dye (ink, toner) is applied to the printing medium precisely and without contact.

The plastic product may be a cartridge for holding viscous filling materials. The base body of the plastic product may be a cartridge container or the usually cylindrical outer wall of a cartridge container or a cartridge chamber. However, the present disclosure is not limited to this application, but may be used in any application.

In step (c), one or more of the following processes are preferably used: corona treatment, flame treatment, plasma treatment. The pre-treatment improves the adhesion of a primer or printing ink applied afterwards to the base body.

Since recycled plastic surfaces have a lower surface energy, they are difficult to wet, which leads to poor adhesion. Better adhesion may be achieved through corona treatment, flame treatment and/or plasma treatment.

In corona treatment, the plastic material is exposed to an electric field between a high-voltage electrode and a grounded counter electrode, which generates a corona discharge. This treatment activates the plastic surface to increase the surface energy of the base body and thus the adhesion of printing inks/dyes.

In flame treatment, the plastic surface is briefly exposed to a controlled, oxidizing flame. This creates polar functional groups on the surface, which increase the surface energy and improve wettability and adhesion.

Similarly, in plasma treatment, the surface is activated by plasma. The surface energy increases and chemical reactivity is improved.

Step (c) may additionally (subsequently) or alternatively comprise the following process step: applying a primer to the base body as an adhesion promoter between the base body and the printing ink.

One or more of the following substances may be used as the primer substance in step (c): UV primer; water-based primer; solvent-based primer. The primer acts as an adhesion promoter between the base body and white or colored printing ink. The primer may be applied in an inking unit or in a separate module, inline, nearline or manually.

The primer serves as an adhesion promoter or adhesive primer that is applied to a plastic surface to improve the adhesion of the printing inks applied subsequently. The composition of usable primers depends basically on the plastic substrate and the ink used. Examples of primers are organosilicones and silanes, polymer solutions (often chlorinated polyolefins—CPOs), aqueous dispersions or solvent-based solutions, etc.

In summary, the primer ensures that the printing ink adheres securely, sharply and permanently to the plastic surface, even if it would have poor adhesion without step (c).

The primer in step (c) is applied in particular by one or more of the following methods: screen printing; digital printing. A combination of these methods or a combination with other methods is also possible. For example, in inkjet printing, the primer may be applied by a dedicated print head before the color ink.

After application in step (c), the primer is preferably dried by one or more of the following methods: irradiation with UV radiation; irradiation with IR radiation; drying with hot air.

UV drying processes are particularly advantageous in digital printing and screen printing on non-absorbent substrates such as plastic. The UV light (ultraviolet radiation) hitting the coating is absorbed and initiates polymerization, causing the primer/ink to cure. In infrared irradiation (IR drying), heat is transferred by radiation. Hot air drying uses the principle of convection (convection drying), namely evaporation and removal of the saturated drying air.

In addition or as an alternative, clear lacquer may be applied to further adjust the chemical properties of the surface. The clear lacquer may be applied before the primer is applied, after the primer is applied and before the white print/color is applied, or after the white print/color is applied and before the color print is applied, or after the color print is applied.

In a preferred embodiment of the present disclosure, the white ink/color is applied in step (d) in one or more layers using one or more of the following methods: screen printing; digital printing.

After application in step (d), the white ink may be dried using one or more of the following methods: irradiation with UV radiation; irradiation with IR radiation; drying with hot air.

Direct printing in step (e) comprises, in particular, color printing, including color inks, for example CMYK or special colors (e.g. Pantone). The order in which the colors are applied is determined depending on the design and the machine. Color printing is usually carried out after white printing. Color printing may be applied inline, nearline or manually.

Digital printing may be combined with other printing technologies such as screen printing or offset printing within the scope of the present disclosure. This means that individual process steps may be carried out using different printing technologies. For example, the white imprint may be applied using screen printing and the color layers using digital printing. All possible combinations are within the scope of the present disclosure.

The imprint applied in step (e) may be dried by one or more of the following methods: irradiation with UV radiation; irradiation with IR radiation; drying with hot air.

In particular, the plastic material in step (a) may have a proportion of at least 5 wt. %, in particular at least 10 wt. %, in particular at least 20 wt. %, in particular at least 30 wt. %, in particular at least 50 wt. %, in particular at least 60 wt. %, in particular at least 70 wt. %, in particular at least 80 wt. %, in particular at least 90 wt.-%, in particular 100 wt. %, of recycled material.

A plastic product according to the present disclosure, in particular a cartridge or a component (e.g. base body), is manufactured according to a method as described above. In particular, it has a durable and easily manufactured imprint.

The recycled material used for the plastic product generally contains at least 1-5 wt. %, in particular 3-5 wt. %, of foreign matter and/or impurities.

The plastic product may have an outer surface, for example a wall, which has an outer side and an inner side, with a print area arranged on the outer surface, which is particularly printed directly by means of digital printing.

Until now, it has not been possible to produce high-quality, durable printed images using direct digital printing on (partially) recycled material with a high recycled content, as in this invention. In particular, if the recycled material is not white but grey or black, color-fast digital printing is not possible; instead, a label has been used in such situations in the prior art. In individual cases, however, the method according to the present disclosure may also be applied to plastic products made of white plastics containing recycled material. The applicant has succeeded in digitally printing plastic products made from or containing recycled material using the aforementioned process. For example, a white background is first printed, followed by the actual (e.g. colored) print image. In particular, rotationally symmetrical digital printing, e.g. on the outside of a cartridge, was successfully carried out as part of the present disclosure.

Recycled material is usually not clear/white, but black, grey, green, etc. However, a bright, white base surface (background) is a basic requirement for brilliant, good color printing. Therefore, the first layer of color is printed in white over the entire surface to be printed. In one embodiment, the white layer(s) may act as (a) barrier layer(s) or as a bonding agent, provided that a suitable material composition of the ink layer is used. However, the applicant has succeeded in digitally printing plastic products made of recyclate material directly. For example, first a white background is printed and the actual printed image is printed on top of the white background. In particular, rotationally symmetrical digital printing, e.g. on the outside of a cartridge, has successfully been carried out as part of the present disclosure. In individual cases, however, the process may also be applied to plastic products with white or white-colored recycled plastics, as described above.

The method according to the present disclosure makes it possible to print on recycled surfaces with high quality and durability. Plastic products according to the present disclosure have a significantly reduced product-related carbon footprint compared to conventional products.

### Conclusion

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A method for manufacturing a plastic product comprising the following steps:
(a) providing at least partially recycled plastic material comprising at least 5% by weight of recycled material;
(b) applying an injection molding or extrusion process to produce a base body of the plastic product;
(c) pretreating the base body of the plastic product;
(d) applying white paint as a base coat to a print area disposed on an outside of the base body as a primer for subsequent color printing;
(e) directly printing on the white base coat of the print area using direct digital printing, a combination of direct digital printing and another printing process, or another printing process.

2. The method according to claim 1, wherein
the plastic product comprising a cartridge configured to hold viscous filling materials.

3. The method according to claim 1, wherein
in step (c), one or more of the following methods are used: corona treatment, flame treatment, plasma treatment.

4. The method according to claim 1, wherein
step (c) comprises applying a second primer to the base body as an adhesion promoter between the base body and a printing ink.

5. The method according to claim 1, wherein
the primer comprises one or more of the following substances in step (c): UV primer, water-based primer, solvent-based primer.

6. The method according to claim 1, wherein
the primer is applied in step (c) by one or more of the following methods: screen printing method, digital printing method.

7. The method according to claim 1, wherein
the primer is dried after application in step (c) by one or more of the following methods: irradiation using UV radiation, irradiation using IR radiation, drying using hot air.

8. The method according to claim 1, wherein
the white paint is applied in step (d) in one or more layers using one or more of the following methods: screen printing method, digital printing method.

9. The method according to claim 1, wherein
the white paint is dried after application in step (d) by one or more of the following methods: irradiation using UV radiation, irradiation using IR radiation, drying using hot air.

10. The method according to claim 1, wherein
the direct printing in step (e) comprises color printing.

11. The method according to claim 1, wherein
the printing applied in step (e) is dried by one or more of the following methods: irradiation using UV radiation; irradiation using IR radiation; drying using hot air.

12. The method according to claim 1, wherein
the plastic material in step (a) has a proportion of at least 10 wt. % of recycled material.

13. The method according to claim 1, wherein
the plastic material in step (a) has a proportion of at least 20 wt. % of recycled material.

14. The method according to claim 1, wherein
the plastic material in step (a) has a proportion of at least 30 wt. % of recycled material.

15. The method according to claim 1, wherein
the plastic material in step (a) has a proportion of at least 50 wt. % of recycled material.

16. The method according to claim 1, wherein
the plastic material in step (a) has a proportion of at least 60 wt. % of recycled material.

17. The method according to claim 1, wherein
the plastic material in step (a) has a proportion of at least 70 wt. % of recycled material.

18. The method according to claim 1, wherein
the plastic material in step (a) has a proportion of at least 80 wt. % of recycled material.

19. A plastic cartridge, wherein the plastic cartridge is manufactured according to the method of claim 1.

20. The plastic product according to claim 19, wherein the recycled material contains at least 1-5 wt. % of foreign matter and/or impurities.
